(19) United States
(12) Patent Application Publication
(10) Pub. No.: US 2026/0117965 A1
(43) Pub. Date: Apr. 30, 2026

(54) MULTIFUNCTIONAL KEYCHAIN FLASHLIGHT WITH INTEGRATED ALARM

(71) Applicant: LB Marketing, Inc., Peachtree Corners, GA (US)

(72) Inventors: Douglas R. Kaye, Alpharetta, GA (US); Jack Grembowitz, Sandy Springs, GA (US)

(21) Appl. No.: 19/369,112

(22) Filed: Oct. 24, 2025

Related U.S. Application Data
(60) Provisional application No. 63/714,415, filed on Oct. 31, 2024.

(51) Int. Cl. F21V 33/00; F21L 4/08; F21V 23/04; F21Y 115/10; G08B 7/06

(52) U.S. Cl. CPC F21V 33/0008; F21L 4/085; F21V 23/0414; F21V 33/0056; F21V 33/0076; G08B 7/06; F21Y 2115/10

(57) ABSTRACT

The present disclosure provides a peripheral device which can include a keychain flashlight having an integrated alarm. A light-emitting element is disposed or otherwise positioned at a first end of the body portion. A power switch is disposed on the housing for controlling the light-emitting element. An alarm switch is disposed on the housing. A coupling assembly is located at a second end of the body portion opposite the first end. A swivel locking device is connected to the coupling assembly and configured to rotate between an open position and a closed position. The peripheral device may include an acoustic transducer, a locking pin, a release switch, textured side surfaces, a rechargeable battery, and a charging port cover.

### CROSS-REFERENCE TO RELATED APPLICATION

This application claims the benefit of and priority to U.S. Provisional Patent Application No. 63/714,415 filed Oct. 31, 2024 entitled “MULTIFUNCTIONAL KEYCHAIN FLASHLIGHT WITH INTEGRATED ALARM,” the contents of which being incorporated by reference in their entirety herein.

### BACKGROUND

Portable lighting devices, such as keychain flashlights, have become increasingly popular due to their convenience and utility in everyday situations. These compact devices often serve multiple purposes, combining illumination with other functionalities to enhance their usefulness. However, existing keychain flashlights may lack additional security features or suffer from limitations in their design, potentially reducing their effectiveness in emergency situations or compromising their durability for long-term use.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a peripheral device is provided. The peripheral device comprises a body portion comprising a housing having processing circuitry housed therein. A light-emitting element is disposed at a first end of the body portion. A power switch is disposed on the housing for controlling the light-emitting element. A coupling assembly is at a second end of the body portion opposite the first end, the coupling assembly comprising a swivel locking device detachably attachable to the housing. The swivel locking device is configured to rotate between an open position and a closed position.

According to other aspects of the present disclosure, the peripheral device may include one or more of the following features. The peripheral device may further comprise an alarm switch positioned on the housing and an acoustic transducer disposed within the housing and operatively connected to the alarm switch. The processing circuitry may be configured to direct the acoustic transducer to emit alarm sound waves based on manipulation of the alarm switch. When the alarm switch is in a first position, the processing circuitry may be configured to direct the acoustic transducer to emit alarm sound waves and, in an instance in which the alarm switch is in a second position, the processing circuitry may be configured to direct the acoustic transducer to not emit any alarm sound waves.

The alarm switch may be aligned within the slot in the housing, the alarm switch being compressible relative to the housing using a biasing element, and being slidable along a longitudinal axis of the housing when the alarm switch is compressed toward the housing. The swivel locking device may comprise a locking pin configured to engage with the coupling assembly in the closed position. The peripheral device may further comprise a release switch disposed on the housing, the release switch configured to disengage the locking pin from the coupling assembly. The peripheral device may further comprise a rechargeable power source disposed within the housing and electrically connected to the light-emitting element. The peripheral device may further comprise a charging port cover disposed on the housing, the charging port cover providing access to a charging port for the rechargeable power source.

According to another aspect of the present disclosure, a multifunctional keychain device is provided. The multifunctional keychain device comprises a housing having a first end and a second end. A light-emitting element is positioned at the first end of the housing. An alarm assembly is disposed within the housing. A power switch is on a surface of the housing for controlling the light-emitting element. An alarm activation mechanism is positioned on the housing. A keychain attachment mechanism is at the second end of the housing, the keychain attachment mechanism including a rotatable arm configured to secure a keychain ring.

According to other aspects of the present disclosure, the multifunctional keychain device may include one or more of the following features. The light-emitting element may comprise a light-emitting diode (LED). The alarm component may comprise an acoustic transducer configured to emit an audible sound wave, the acoustic transducer comprising at least one of a speaker and a piezoelectric buzzer. The alarm activation mechanism may comprise a slide switch configured to activate the audible alarm.

The rotatable arm of the keychain attachment mechanism may comprise a locking pin configured to secure the rotatable arm in a closed position. The alarm activation mechanism may comprise a slider portion slidably engaged with the housing, the housing comprising a first support arm and a second support arm defining a slot therebetween, the slider portion being positioned within the slot and movable between a first position and a second position. The multifunctional keychain device may further comprise a biasing element operatively connected to the slider portion, the biasing element configured to bias the slider portion away from the housing, wherein the slide portion is compressible toward the housing against the biasing element and slidable along a longitudinal axis of the housing when compressed.

According to another aspect of the present disclosure, a peripheral device is provided. The peripheral device comprises a body portion comprising a housing having processing circuitry housed therein, a power source, a light-emitting element disposed at a first end of the body portion electrically coupled to the power source, and a power switch disposed on the housing for controlling the light-emitting element. An alarm switch is positioned on the housing and an acoustic transducer is disposed within or on the housing and operatively connected to the alarm switch. The processing circuitry is configured to direct the acoustic transducer to emit alarm sound waves based on manipulation of the alarm switch. The alarm switch is aligned within the slot in the housing such that the alarm switch is compressible relative to the housing and slidable along a longitudinal axis of the housing when the alarm switch is compressed toward the housing.

According to other aspects of the present disclosure, the peripheral device may include one or more of the following features. The peripheral device may further comprise a coupling assembly at a second end of the body portion opposite the first end, and a swivel locking device connected to the coupling assembly, the swivel locking device configured to rotate between an open position and a closed position. The swivel locking device may comprise a locking pin configured to engage with the coupling assembly in the closed position, and the peripheral device may further comprise a release switch disposed on the housing, the release switch configured to disengage the locking pin from the coupling assembly. The acoustic transducer may be configured to emit alarm sound waves at a decibel level of approximately 120 decibels. The power switch may be configured to cycle the light-emitting element through multiple modes of operation, the multiple modes comprising at least one of continuous illumination, pulsating light, and flashing patterns. The peripheral device may further comprise a biasing element disposed within the housing and operatively connected to the alarm switch, the biasing element configured to bias the alarm switch away from the housing.

According to another aspect of the present disclosure, a method for providing a multifunctional keychain device is provided. The method comprises providing a housing having a first end and a second end. The method may further comprise positioning a light-emitting element at the first end of the housing and disposing an alarm assembly within the housing. A power switch may be positioned on a surface of the housing for controlling the light-emitting element. The method may include positioning an alarm activation mechanism on the housing and providing a keychain attachment mechanism at the second end of the housing, the keychain attachment mechanism including a rotatable arm configured to secure a keychain ring.

According to other aspects of the present disclosure, the method may include one or more of the following features. The method may comprise providing the light-emitting element as a light-emitting diode (LED). The alarm assembly may be provided as an acoustic transducer configured to emit an audible sound wave, the acoustic transducer comprising at least one of a speaker and a piezoelectric buzzer.

The method may include providing the alarm activation mechanism as a slide switch configured to activate the audible alarm. The rotatable arm of the keychain attachment mechanism may be provided with a locking pin configured to secure the rotatable arm in a closed position. The method may comprise providing the alarm activation mechanism as a slider portion slidably engaged with the housing, the housing comprising a first support arm and a second support arm defining a slot therebetween, the slider portion being positioned within the slot and movable between a first position and a second position. The method may further comprise providing a biasing element operatively connected to the slider portion, the biasing element configured to bias the slider portion away from the housing, wherein the slide portion is compressible toward the housing against the biasing element and slidable along a longitudinal axis of the housing when compressed.

The foregoing general description of the illustrative embodiments and the following detailed description thereof are merely example aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a perspective view of a peripheral device according to various embodiments of the present disclosure.

FIG. 2 depicts another perspective view of the peripheral device of FIG. 1 according to various embodiments of the present disclosure.

FIG. 3 shows a top view of the peripheral device of FIG. 1 according to various embodiments of the present disclosure.

FIG. 4 shows a bottom view of the peripheral device of FIG. 1 according to various embodiments of the present disclosure.

FIG. 5 shows a front view of the peripheral device of FIG. 1 according to various embodiments of the present disclosure.

FIG. 6 depicts a rear view of the peripheral device of FIG. 1 according to various embodiments of the present disclosure.

FIG. 7 shows a side view of the peripheral device of FIG. 1 according to various embodiments of the present disclosure.

FIG. 8 presents another side view of the peripheral device of FIG. 1 according to various embodiments of the present disclosure.

FIG. 9 illustrates a top perspective view of the peripheral device with its housing omitted according to various embodiments of the present disclosure.

FIG. 10 illustrates a bottom perspective view of the peripheral device with its housing omitted according to various embodiments of the present disclosure.

FIGS. 11A-11B show elevation cross-sectional views of the peripheral device in a locked and unlocked state according to various embodiments of the present disclosure.

FIGS. 12A-12B show perspective cross-sectional views of the peripheral device in a locked and unlocked state according to various embodiments of the present disclosure.

FIG. 13 is a cross-sectional view of the peripheral device of FIG. 1 featuring callout region 14 showing an alarm switch in a disabled, non-compressed state according to various embodiments of the present disclosure.

FIG. 14 is an enlarged view of the callout region 14 of FIG. 13 according to various embodiments of the present disclosure.

FIG. 15 is a cross-sectional view of the peripheral device of FIG. 1 featuring callout region 16 showing an alarm switch in a disabled, compressed state according to various embodiments of the present disclosure.

FIG. 16 is an enlarged view of the callout region 16 of FIG. 15 according to various embodiments of the present disclosure.

FIG. 17 is a cross-sectional view of the peripheral device of FIG. 1 featuring callout region 18 showing the alarm switch in a compressed, slid, and enabled state according to various embodiments of the present disclosure.

FIG. 18 is an enlarged view of the callout region 18 of FIG. 17 according to various embodiments of the present disclosure.

FIGS. 19 and 20 are partial views of a sliding mechanism of the peripheral device of FIG. 1 according to various embodiments of the present disclosure.

FIG. 21 is a cross-sectional view of the peripheral device of FIG. 1 featuring callout region 22 according to various embodiments of the present disclosure.

FIG. 22 is an enlarged view of the callout region 22 of FIG. 21 according to various embodiments of the present disclosure.

FIG. 23 is a cross-sectional view of the peripheral device of FIG. 1 featuring callout region 24 according to various embodiments of the present disclosure.

FIG. 24 is an enlarged view of the callout region 24 of FIG. 23 according to various embodiments of the present disclosure.

FIG. 25 is a cross-sectional view of the peripheral device of FIG. 1 featuring callout region 26 according to various embodiments of the present disclosure.

FIG. 26 is an enlarged view of the callout region 26 of FIG. 25 according to various embodiments of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The field of portable lighting devices faces several challenges that may limit their effectiveness and user satisfaction. Traditional keychain flashlights often suffer from limited functionality, providing only basic illumination without additional features that could enhance their utility in various situations. Many existing devices lack adequate security features, leaving users without options for alerting others or deterring potential threats during emergency situations. Durability concerns may also plague conventional keychain flashlights, as they are frequently subjected to rough handling, drops, and exposure to various environmental conditions. The compact nature of these devices may result in fragile construction that can compromise long-term reliability. Additionally, many portable lighting devices may have inadequate attachment mechanisms that can fail under stress or become accidentally disengaged, potentially resulting in loss of the device or attached keys.

Power management represents another significant challenge in the field. Many keychain flashlights may rely on disposable batteries that can drain unexpectedly, leaving users without illumination when needed most. Some devices may lack efficient power management systems, resulting in shortened battery life or inconsistent performance over time. User interface design may present additional difficulties, as many portable lighting devices may have controls that are difficult to operate in low-light conditions or while wearing gloves. Some devices may be prone to accidental activation, which can drain the battery or cause unwanted illumination at inappropriate times. Conversely, other devices may have controls that are too difficult to activate quickly in emergency situations.

Furthermore, many existing keychain flashlights may lack versatility in their lighting modes, offering only a single brightness level or illumination pattern. This limitation may reduce their effectiveness in different scenarios, such as close-up tasks requiring lower light levels or emergency signaling requiring bright or flashing patterns. The integration of multiple functions into a single compact device may present engineering challenges related to component placement, electrical interference, and mechanical complexity. These challenges may result in devices that are either too large for convenient carry or that sacrifice reliability in favor of feature integration.

Accordingly, various embodiments are described herein for a portable peripheral lighting device, generally referred to herein as a peripheral device or a keychain flashlight, having integrated security features. In particular, various embodiments for a multifunctional keychain flashlight are disclosed that may combine illumination capabilities with alarm functionality and a secure attachment mechanism. The multifunctional keychain flashlight may include a compact, low-profile body portion housing various components. A light-emitting element may be disposed at at least one end of the body portion to provide illumination. The light-emitting element may be controlled by a power switch located on the housing, which is operatively coupled to (e.g., in electrical communication with) a printed circuit board (e.g., processing circuitry) of the device, as can be appreciated.

In some aspects, the keychain flashlight can include an alarm. The keychain flashlight includes an alarm switch assembly positioned on the housing to activate an audible alarm using an acoustic transducer on the flashlight. The alarm may provide an additional security measure for users in emergency situations. The keychain flashlight may incorporate a coupling assembly at an end opposite the light-emitting element, which may include a swivel locking device in some embodiments. The swivel locking device may be configured to rotate between open and closed positions, allowing for secure attachment of keys or other items.

In certain implementations, the body portion may have a generally rectangular cross-section. The housing may include textured side surfaces to enhance grip. A rechargeable or disposable power source (e.g., a battery) may power the light-emitting element and alarm components. A charging port cover may provide access for recharging the power source in embodiments in which the power source includes a rechargeable battery. Accordingly, the multifunctional keychain flashlight described herein may offer users a compact, versatile device combining illumination, security features, and convenient attachment options in a single portable unit. The integration of multiple functionalities may enhance the utility and effectiveness of the device for everyday carry and emergency preparedness.

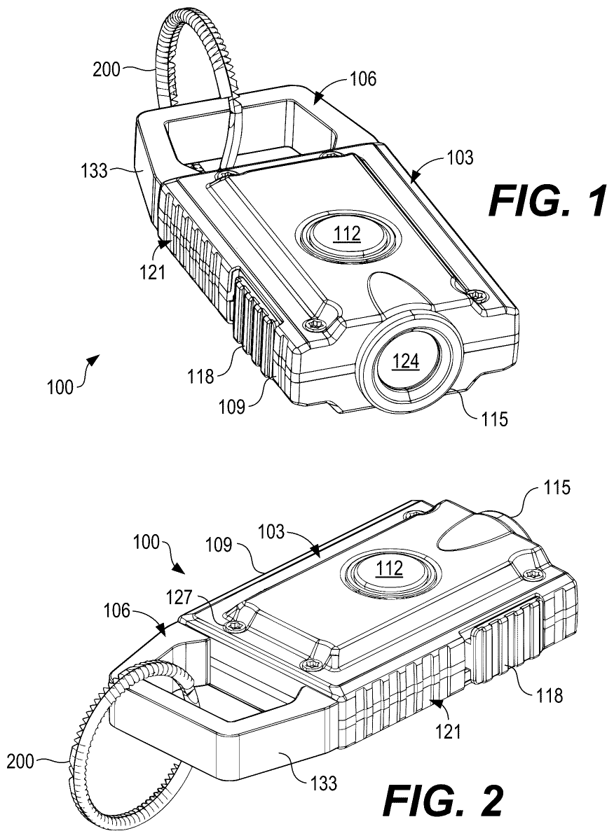

FIGS. 1 and 2 illustrate perspective views of a peripheral device 100, which includes a multifunctional keychain flashlight and alarm device. The peripheral device 100 can include a body portion 103, a coupling assembly 106 extending from the body portion 103, a housing 109, a power switch 112, a bezel 115, an alarm switch assembly 118, textured side surfaces 121, a lens 124, housing coupling features 127, and a swivel locking device 133. A keychain ring 200 can be attached to the coupling assembly 106; however, other items can be coupled to the coupling assembly 106, such as a purse, lanyard, backpack, apparel, and so forth using or through direct attachment to the coupling assembly 106, or through indirect attachment using the keychain ring 200, as can be appreciated.

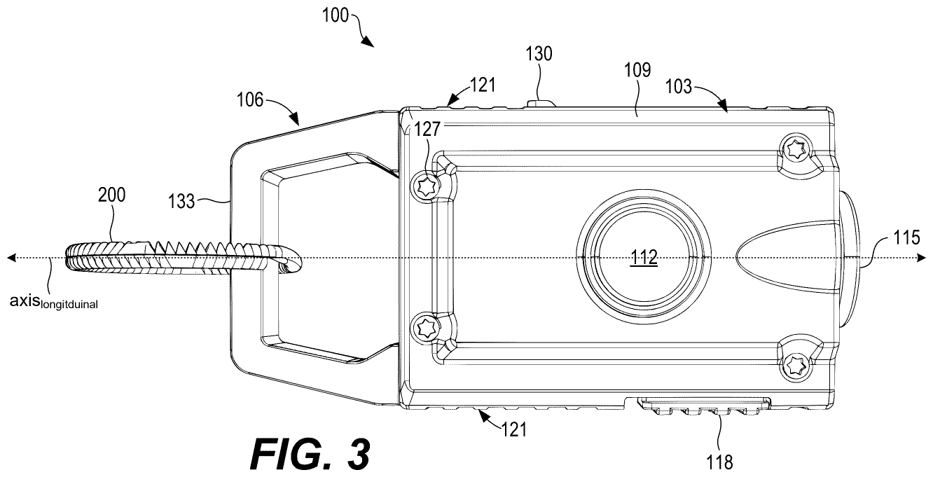

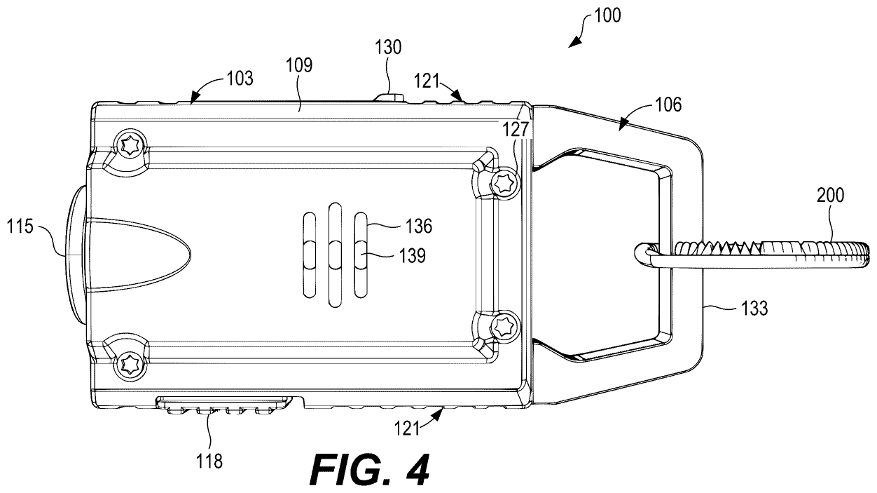

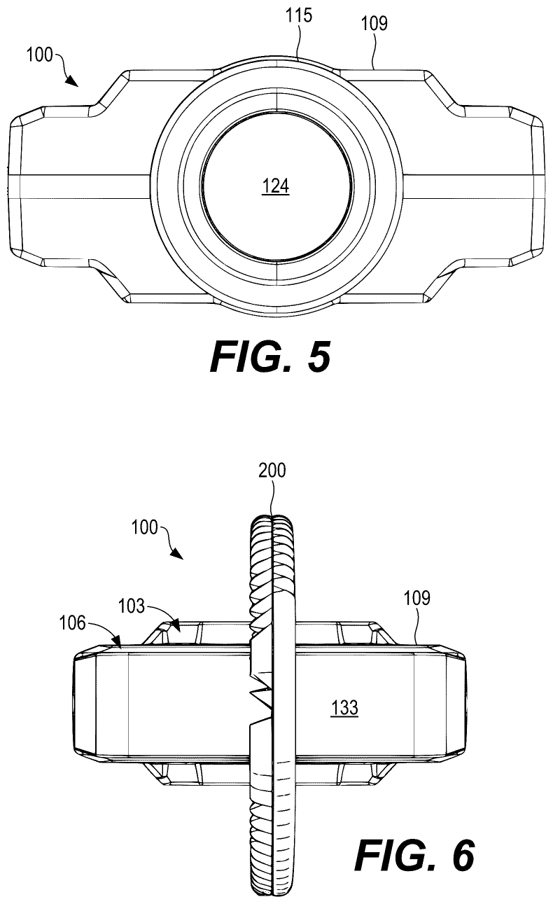

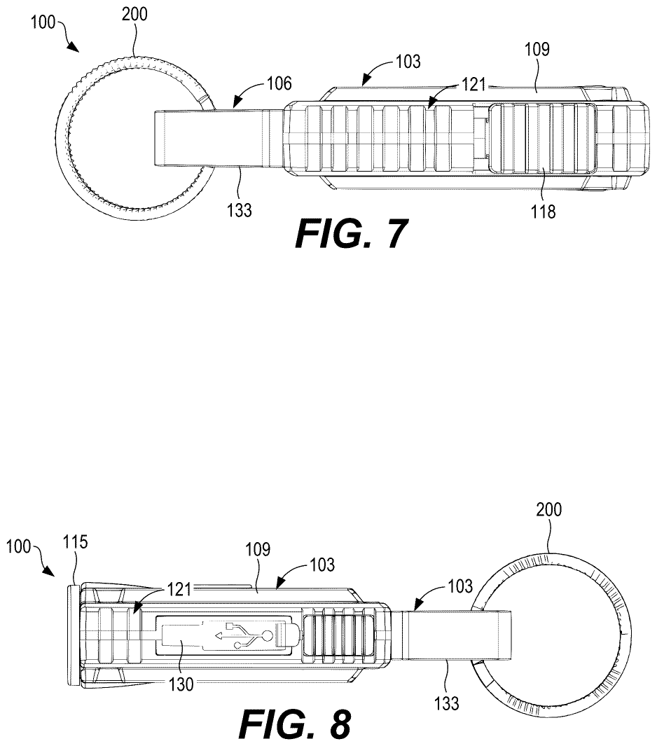

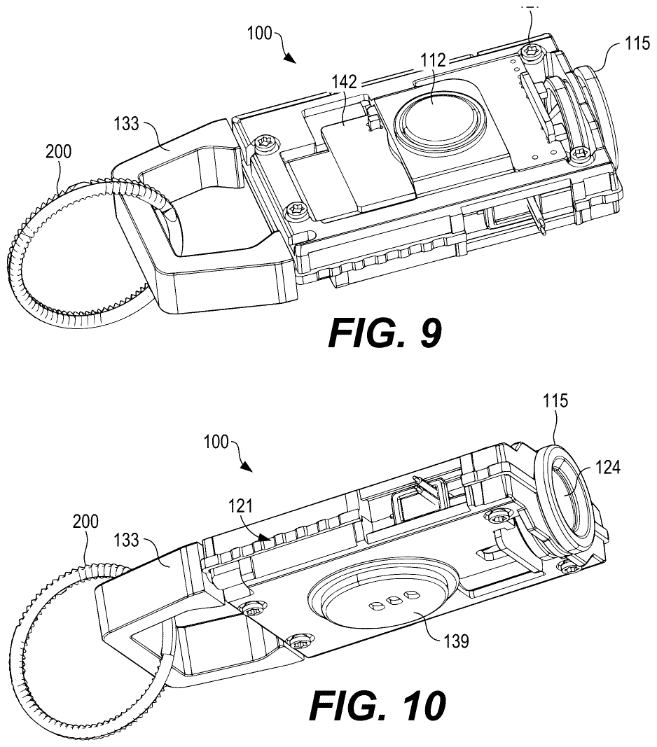

FIG. 3 shows a top view of the peripheral device 100, FIG. 4 shows a bottom view of the peripheral device 100, and FIGS. 5 and 6 depict front and rear views of the peripheral device 100, respectively. FIGS. 7 and 8 show side views of the peripheral device 100. FIGS. 9 and 10 provide perspective views of the peripheral device 100 with a portion of the housing 109 omitted, revealing internal components, as will be described.

Referring collectively to FIGS. 1-10, various aspects of a peripheral device 100 according to embodiments of the present disclosure are shown. To begin, the peripheral device 100 may be a multifunctional keychain flashlight having an integrated alarm. As shown in FIGS. 1 and 2, the peripheral device 100 can include a body portion 103. The body portion 103 can extend longitudinal, for instance, along a longitudinal axis axis_{longitudinal}. The body portion 103 can be symmetrical along a centerline (e.g., the longitudinal axis axis_{longitudinal} of FIG. 3). The body portion 103 can have a generally square or rectangular cross-section and can include a housing 109 formed of a polymer or other rigid material, which can encapsulate internal circuitry, such as a printed circuit board (PCB), a light-emitting element (e.g., a light-emitting diode (LED)), a power source (e.g., one or more rechargeable and/or disposable batteries), and so on. The housing 109, in some implementations, can include textured side surfaces 121 via a multitude of ridges, which can enhance grip and handling of the peripheral device 100. The housing 109 may thus include lateral sides having ridged, non-uniform surfaces.

A coupling assembly 106 may be located at one end of the body portion 103, and may be detachably attachable to the body portion 103 or the housing 109 thereof. The coupling assembly 106 can provide a connection point for a keychain ring 200, allowing the device to be easily carried or attached to other objects. The coupling assembly 106 may include a swivel locking device 133 in some embodiments. The swivel locking device 133 may be configured to translate partially along a longitudinal axis axis_{longitudinal} and rotate between open and closed positions, as will be described.

At the opposite end of the body portion 103 from the coupling assembly 106, a bezel 115 can be provided. The bezel 115 can surround a lens 124, which can cover a light-emitting element (not shown), where the light-emitting element can be disposed within the housing 109, as can be appreciated. The bezel 115 can project from the housing 109. The light-emitting element positioned within the housing 109 can be controlled by a power switch 112 located on the top surface of the housing 109, as shown in FIG. 3. For instance, the power switch 112 is operably connected to a printed circuit board or other processing circuitry, which is, in turn, operably coupled to the light-emitting element to direct illumination or modes of illumination of the light-emitting element based on a manipulation of the power switch 112.

The peripheral device 100 can include an alarm switch assembly 118, which can be controlled by a printed circuit board 142 or other processing circuitry of the peripheral device 100. The alarm switch assembly 118 can be positioned or otherwise accessed on the side of the housing 109, as depicted in FIGS. 1, 3, 4, 7, and 8, although it is understood that other locations of the alarm switch assembly 118 may be employed depending on a desired configuration.

Cutouts 136 can be provided on the bottom of the device, as shown in FIG. 4, behind which an acoustic transducer 139 of an alarm device can be located. The acoustic transducer 139 can include a speaker, a piezoelectric transducer (e.g., a piezo buzzer), and so on, that emits audible sound waves, referred to as alarm sound waves. In some embodiments, the alarm sound waves can include human-audible sound waves or ultrasonic sound waves. The ultrasonic sound waves can include, for example, sound waves that are not heard by humans, but can be heard by other animals (e.g., dogs), or can be another type of ultrasonic sound wave. The acoustic transducer 139 can be fully positioned within the housing 109, or can project from the housing 109 in some implementations. The peripheral device 100 can be powered by power source including, but not limited to, a rechargeable battery, such as a lithium-ion (Li-ion) battery, as well as disposable batteries, or a combination thereof. A charging port cover 130 can be provided on the housing 109 to allow access for recharging a rechargeable battery, as shown in FIGS. 3, 4, 7, and 8. In addition to or in place of a charging port, the charging port cover 130 can provide access to a battery storage compartment for disposable battery replacement.

FIGS. 9 and 10 provide views of the peripheral device 100 with the housing 109 omitted for explanatory purposes revealing internal components such as a printed circuit board 142. The printed circuit board 142 may act as processing circuitry of the peripheral device 100 that controls various functions of the peripheral device 100, such as the illumination and modes of illumination of the light-emitting element, the activation or deactivation of the alarm via the acoustic transducer 139 based on an orientation of the alarm switch assembly 118, and so forth. In some embodiments, the printed circuit board 142 includes or is operatively coupled to a PCB switch, as will be described.

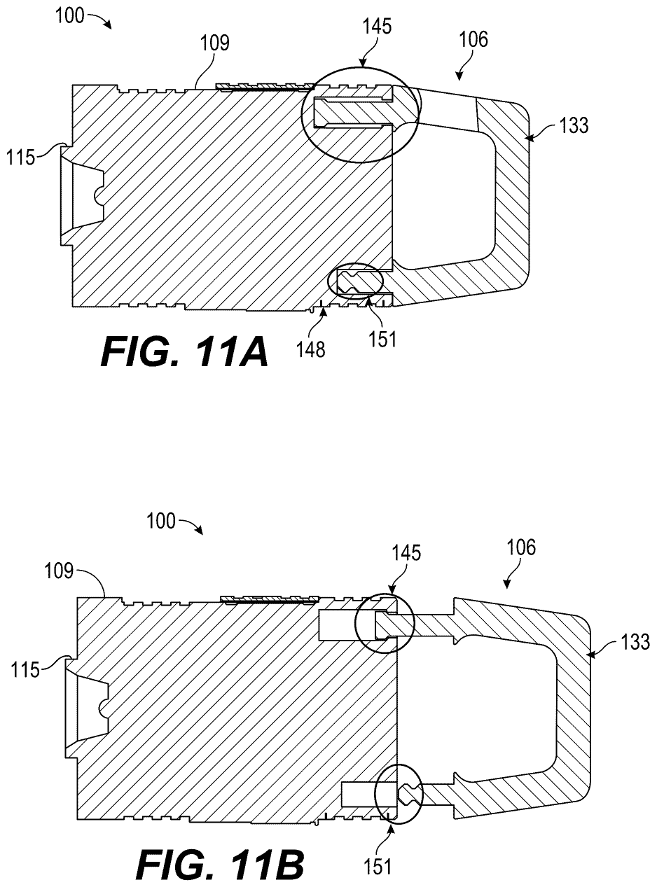

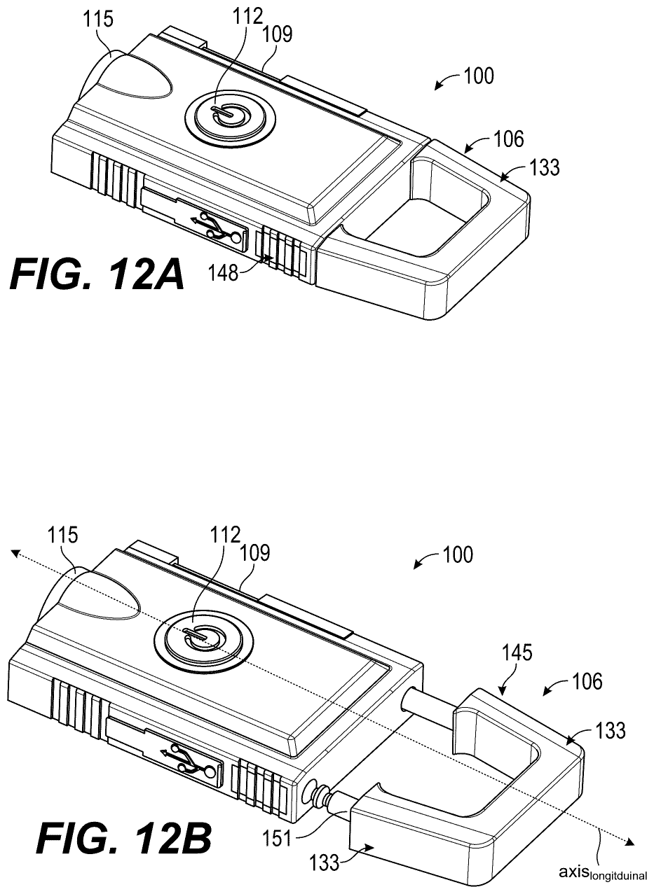

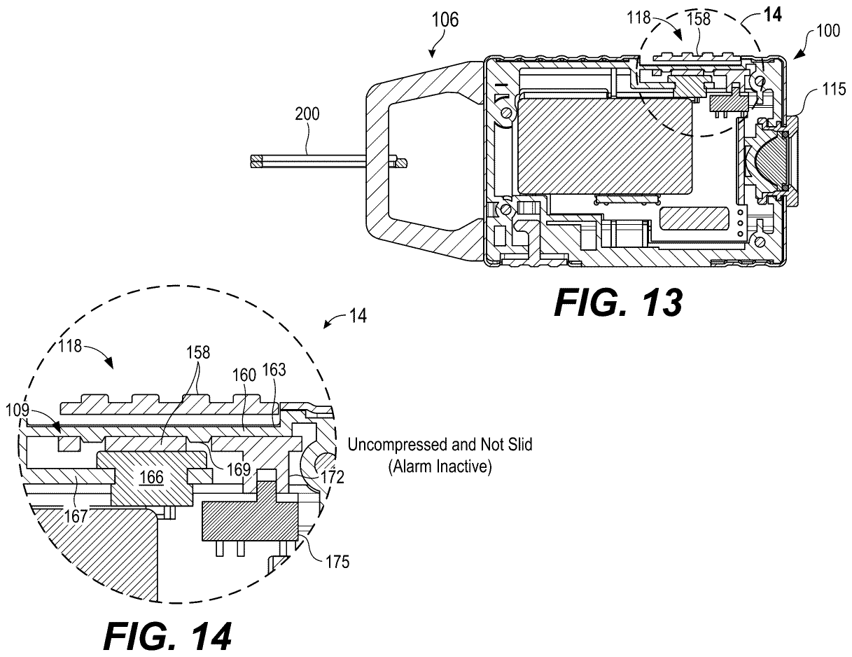

The coupling assembly 106 can include a swivel locking device, providing similar functionality to a swivel lock. The swivel locking abilities of the peripheral device 100 is depicted in detail in FIGS. 11A-11B and 12A-12B. The peripheral device 100 can include a swivel pin 145 fixedly and rotatably coupled to a first side of the swivel locking device 133, a release switch 148, and a locking pin 151 detachably coupled to a second side of the swivel locking device 133. These components can work together to allow the swivel locking device 133 to rotate between open and closed positions, providing secure attachment for keys, bags, luggage, and other items.

For instance, the swivel locking device 133 can be configured to rotate between an open position (shown in FIG. 11B and FIG. 12B) and a closed position (shown in FIG. 11A and FIG. 12A), allowing for secure attachment and easy release of items such as keys or accessories (e.g., keychain ring 200). The swivel locking device 133 can translate or move horizontally relative to the longitudinal axis axis_{longitudinal}, and can further pivot or rotate about the swivel pin 145. In some aspects, the swivel locking device 133 can include the locking pin 151, where the locking pin 151 is configured to engage with the body portion 103 when in the closed position. The locking pin 151 can be spring-loaded in some embodiments, or otherwise biased to maintain engagement with the coupling assembly 106, ensuring a secure closure, as will be further described.

In some embodiments, the release switch 148 can be disposed on the housing 109 of the peripheral device 100, and can be a user-actuated button for unlocking the swivel locking device 133. For instance, the release switch 148 can be configured to disengage the locking pin 151 from an aperture of the housing 109 when activated. Upon pressing or otherwise manipulating the release switch 148, in some embodiments, the locking pin 151 can retract, allowing the swivel locking device 133 to disengage from a first side of the body portion 103 and rotate freely about the swivel pin 145. Alternatively, a latch (not shown) engaged with the locking pin 151 can disengage, freeing the locking pin 151 from an attachment to the housing 109.

In some implementations, the swivel locking device 133 can be configured to pop out or otherwise release upon pressing the release switch 148. This release can provide a quick and easy way for users to access the open position of the swivel locking device 133. The popping or releasing action can be facilitated by an ejection spring, as will be discussed, or other suitable means that applies a force to the swivel locking device 133 when the locking pin 151 is disengaged, as can be appreciated.

The swivel locking device 133 can rotate around a swivel pin 145, which can serve as the pivot point for movement of the swivel locking device 133. The swivel pin 145 can be securely attached to the coupling assembly 106 or integrated into the housing 109 of the peripheral device 100. In some cases, the swivel locking mechanism can incorporate additional features to enhance its functionality or durability. For example, the mechanism may include a damping element to control the speed of the swivel locking device 133 as it opens or closes.

The locking pin 151 and corresponding engagement surfaces may be made of wear-resistant materials to ensure long-term reliability of the locking mechanism. The design of the swivel locking mechanism may allow for one-handed operation, enabling users to easily attach or detach the peripheral device 100 from keyrings or other objects while holding other items. This can enhance the overall usability and convenience of the device in various everyday scenarios.

Referring to FIGS. 12A-12B, additional aspects of the peripheral device 100 are illustrated, showing the coupling assembly 106 in closed and open configurations, respectively. In FIG. 12A, the peripheral device 100 is shown in its closed configuration. In some embodiments, the housing 109 of the device 100 can include the power switch 112, which is embodied as a circular button on its top face, which is operatively coupled to the printed circuit board 142 to control a mode of illumination of light-emitting element. The release switch 148 is positioned on a lower portion of the device, integrated into the textured surface of the housing 109.

In FIG. 12B, the peripheral device 100 is shown in its open configuration. The swivel locking device 133 is extended from the main body, connected by a swivel pin 145. This swivel mechanism allows the device 133 to rotate away from the housing 109, creating an opening for attaching keys or other items. The locking pin 151 can secure the swivel locking device 133 in its closed position when not in use. The release switch 148 can be configured to disengage the locking pin 151 from the coupling assembly 106. When activated, the release switch 148 can cause the locking pin 151 to retract, allowing the swivel locking device 133 to move freely between its open and closed positions. This mechanism can provide a quick and convenient way for users to attach or detach items from the peripheral device 100.

In some implementations, the release switch 148 can have a low profile to prevent accidental activation while still being easily accessible when needed. The switch can incorporate tactile feedback in some implementations to provide users with a clear indication when it has been activated. The peripheral device 100 can be constructed with both smooth and textured surfaces, enhancing grip and aesthetic appeal. The materials can include aluminum, polymer materials, stainless steel, a combination thereof, and other suitable materials. In some aspects, certain components such as the release switch 148 and parts of the swivel mechanism can include contrasting colors or materials to provide visual cues for interactive elements of the device.

The design of the peripheral device 100 allows for one-handed operation of the swivel locking device 133. Users may be able to press the release switch 148 and open the swivel locking device 133 with a single hand, facilitating ease of use in various situations. In some aspects, the power switch 112 of the peripheral device 100 can be operatively coupled to the printed circuit board 142 or other processing circuitry of the device 100 to toggle the light-emitting element through multiple modes of operation. These modes may include, but are not limited to, continuous illumination, pulsating light, and flashing patterns. The ability to cycle through various lighting modes may enhance the versatility of the device for different situations, such as signaling for help or conserving battery power.

The alarm of the peripheral device 100 can be designed to produce a high-decibel sound when activated. In some implementations, the alarm may generate a sound at approximately 120 decibels (dB), which may be sufficiently loud to attract attention in emergency situations or deter potential threats. The specific decibel level may vary depending on the particular design and components used in the device 100.

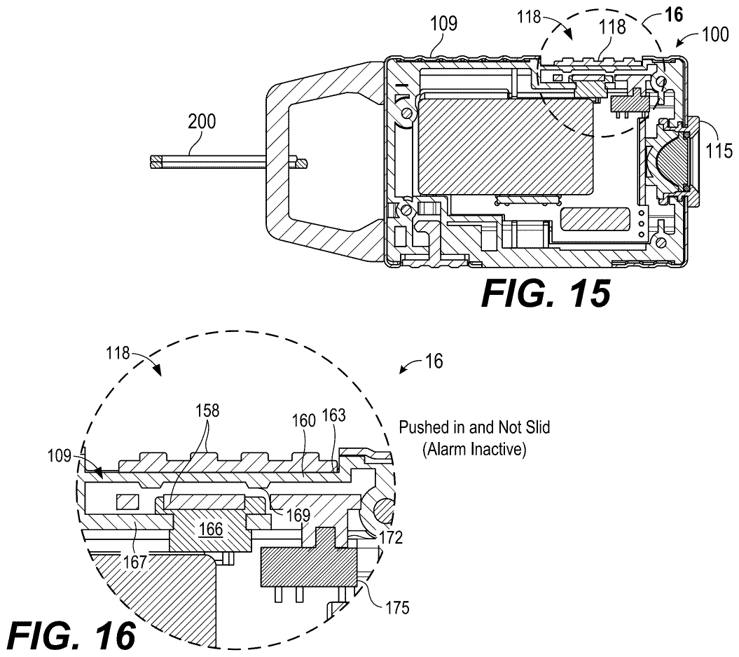

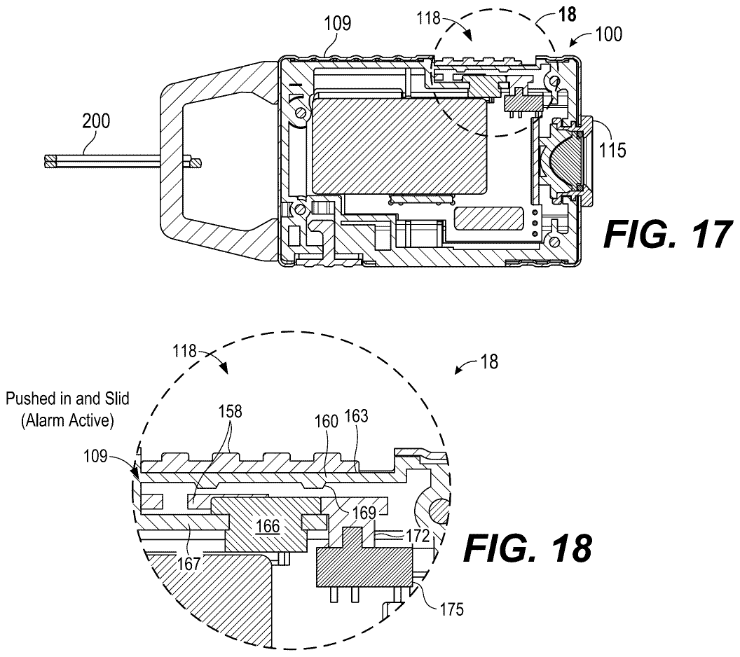

FIGS. 13-16 illustrate detailed cross-sectional views of the alarm switch assembly 118 of the peripheral device 100, showing the alarm switch assembly 118 in both disabled and enabled positions. The alarm switch assembly 118, in various embodiments, can include a press-and-slide mechanism to prevent accidental activations of the alarm, while permitting one-handed operation of the peripheral device 100. More specifically, FIGS. 13-14 show the alarm switch assembly 118 in a non-enabled state (e.g., where the alarm is disabled and no sound is emitted). FIGS. 15-16 show the alarm switch assembly 118 in a pressed, but non-slid state (e.g., where the alarm is disabled and no sound is emitted), and FIGS. 17-18 show the alarm switch assembly 118 in a pressed and slid state (e.g., where the alarm is disabled and no sound is emitted).

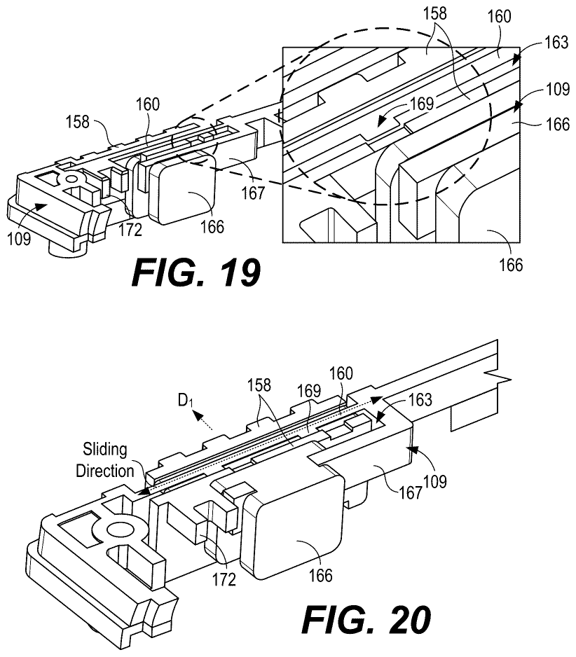

FIG. 14 is an enlarged view of the callout region 14 of FIG. 13, FIG. 16 is an enlarged view of callout region 16 of FIG. 15, and FIG. 18 is an enlarged view of callout region 18 of FIG. 17. FIG. 19 shows a rear view of the alarm switch assembly 118 in a non-slid position, and FIG. 20 shows a rear view of the alarm switch assembly 118 in a slid position where the alarm is activated, as will be described.

Referring to FIGS. 13-20 collectively, the alarm switch assembly 118 includes a slider portion 158 slidably engaged with the housing 109. The slider portion 158 can slide or otherwise translate between a first position, shown in FIG. 14, and a second position, shown in FIG. 18. To this end, the housing 109 includes a support arm 160 (e.g., a first support arm 160) that defines a slot 163, where the slider portion 158 has a portion slidably situated in the slot 163. A front face of the slider portion 158 can be rugged or have a textured, non-uniform surface, and can be exposed through the housing 109 such that an operator can slide the slider portion 158 using a thumb or other digit.

The alarm switch assembly 118 can include a biasing element 166 that biases the slider portion 158 away from the housing 109 (e.g., in a direction d₁). In some embodiments, the biasing element 166 includes a silicon pad that is folded over or otherwise situated relative to another support arm 167 (e.g., a second support arm 167) of the housing 109, where the second support arm 167 can be parallel to the first support arm 160. However, in other embodiments, a spring mechanism can be employed to bias the slider portion 158 in direction d₁.

In any event, the slot 163 can be situated between the first support arm 160 and the second support arm 167 of the housing 109. The first support arm 160 can include detents 169 or projections positioned on a rear side of the first support arm 160 that prevent the translation or sliding of the slider portion 158, for instance, when the slider portion 158 is uncompressed and the alarm is in the off state (e.g., FIG. 14). By pressing on the slider portion 158 in a direction opposite direction d₁, the biasing element 166 is compressed, and a fraction of the slider portion 158 positioned in the slot 163 becomes free of the detents 169, permitting the slider portion 158 to freely slide within the slot 163.

The slider portion 158 may further include prongs 172 extending from a rear portion of the slider portion 158, where the prongs 172 extend further into the housing 109. The prongs 172 may include two members having a space positioned therebetween. A PCB switch 175 of a printed circuit board may be positioned in the space between the prongs 172. The PCB switch 175 can include a slider switch, for example, that when enabled, causes the processing circuitry to enter an alarm state (e.g., where audio waves are emitted) or that when disabled, causes the processing circuitry to exit the alarm state (e.g., where no audio waves are emitted). The biasing element 166 can be situated laterally to the prongs 172 and can couple to or interface with the prongs 172. It is understood, however, that, while the prongs 172 slide along with movement of the slider portion 158, the biasing element 166 will remain stationary.

Accordingly, the alarm switch assembly 118 may include a push-and-slide switch that activates or disables the alarm feature based on an orientation of the slider portion 158, which may help prevent accidental activation while still allowing for quick and easy use when needed. The processing circuitry of the peripheral device 100 may be implemented in the form of a printed circuit board having a PCB switch 175. FIGS. 13-16 show the PCB switch 175 in a non-activated state (where the alarm is not active), and FIGS. 17-18 show the PCB switch 175 in an activated state (where the alarm is active).

The alarm switch assembly 118 may be designed with specific tolerances to ensure reliable operation while maintaining a compact form factor of the peripheral device 100. In some implementations, the slider portion 158 may include surface texturing or other grip-enhancing features to facilitate user interaction, particularly in low-light conditions or when wearing gloves. The mechanism may also incorporate spring-loaded elements, such as the biasing element 166, that bias the slider portion 158 toward its default position and where the slider portion 158 is retained by the detents 169, ensuring that the alarm switch returns to a safe, non-activated state when not in use.

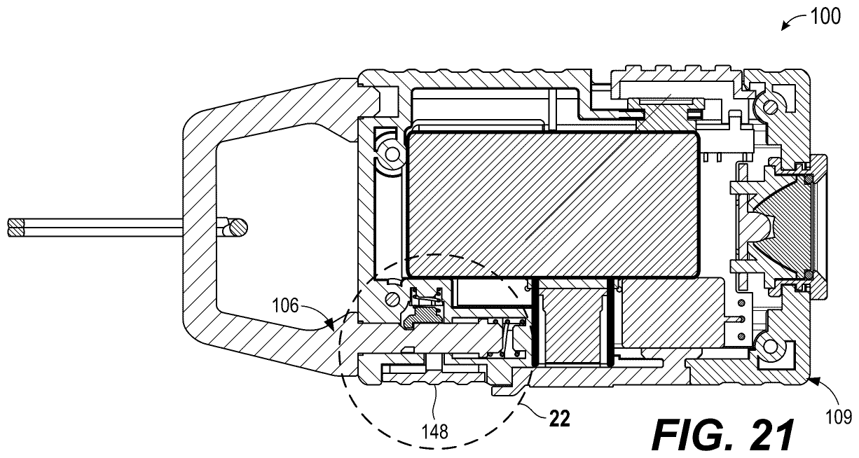

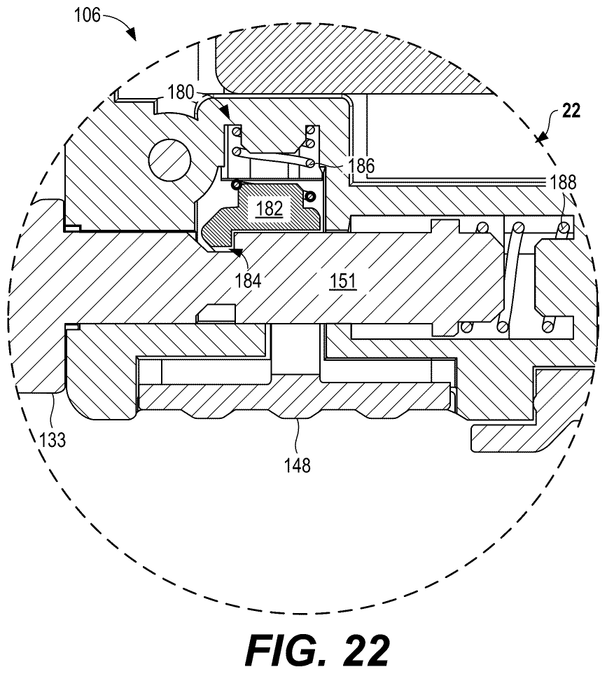

Referring next to FIGS. 21 and 22, a cross-sectional view of the peripheral device 100 is shown according to various embodiments. Specifically, FIG. 21 includes callout region 22, where callout region 22 is shown in enlarged detail in FIG. 22. In some embodiments, the coupling assembly 106 can include a swivel locking device, providing similar functionality to a swivel lock. The peripheral device 100 can include a swivel pin 145 (FIGS. 11A and 11B) fixedly and rotatably coupled to a first side of the swivel locking device 133, which can serve as a pivot axis for the swivel locking device 133. The peripheral device 100 can further include a release switch 148 and a locking pin 151 detachably coupled to a second side of the swivel locking device 133. The locking pin 151 can extend from the swivel locking device 133, as can be appreciated.

The locking pin 151 can interface with a spring release latch assembly 180 in some embodiments. The spring release latch assembly 180 includes a latch 182 that is pivotably engaged with a notch 184 on the locking pin 151 or the swivel locking device 133. The latch 182 can be biased in the closed position (shown in FIG. 22) using a spring 186. A compression or other manipulation of the release switch 148 can cause the spring 186 to release force acting on the latch 182, which causes the latch 182 to disengage from the notch 184 on the locking pin 151, permitting the locking pin 151 to release from its locked position, shown in FIG. 22. An ejection spring 188 can be positioned relative to the locking pin 151 such that, when the latch 182 is disengaged from the notch 184, the locking pin 151 is released from its position with some force. The force may be sufficient for some or all of the locking pin 151 to release from the housing 109.

Thereafter, the swivel locking device 133 can rotate between an open position (shown in FIG. 11B and FIG. 12B) and a closed position (shown in FIG. 11A and FIG. 12A), allowing for secure attachment and easy release of items such as keys or accessories (e.g., keychain ring 200). The swivel locking device 133 can translate or move horizontally relative to the longitudinal axis axis_{longitudinal}, and can further pivot or rotate about the swivel pin 145. In some aspects, the swivel locking device 133 can include the locking pin 151, where the locking pin 151 is configured to engage with the body portion 103 when in the closed position. The locking pin 151 can be spring-loaded in some embodiments, or otherwise biased to maintain engagement with the coupling assembly 106, ensuring a secure closure, as will be further described.

In some embodiments, a release switch 148 can be disposed on the housing 109 of the peripheral device 100. The release switch 148 can be configured to disengage the locking pin 151 from the coupling assembly 106 when activated. Upon pressing or otherwise manipulating the release switch 148, the locking pin 151 can retract, allowing the swivel locking device 133 to disengage from a first side of the body portion 103 and rotate freely about the swivel pin 145.

In the configuration shown in FIGS. 21 and 22, the locking pin 151 may serve multiple functions. Namely, the locking pin 151 acts as both the locking mechanism and the swivel pin for the swivel locking device 133, where this configuration differs from that depicted in FIGS. 11A and 11B, where the swivel pin 145 and locking pin 151 may be separate components. In FIGS. 21 and 22, the locking pin 151 may provide both the pivot point for rotational movement of the swivel locking device 133 and the locking engagement with the coupling assembly 106.

The spring release latch assembly 180 may be designed to accommodate the dual functionality of the locking pin 151. When the release switch 148 is activated, the latch 182 may disengage from the notch 184, allowing the locking pin 151 to function as a pivot point while releasing its locking engagement. The ejection spring 188 may provide force to facilitate the transition from the locked to the unlocked state, while still maintaining the role of the locking pin 151 as a rotational axis for the swivel locking device 133.

In some implementations, the swivel locking device 133 can be configured to pop out or otherwise release upon pressing the release switch 148. This release can provide a quick and easy way for users to access the open position of the swivel locking device 133. The popping or releasing action can be facilitated by a spring mechanism (not shown) or other suitable means that applies a force to the swivel locking device 133 when the locking pin 151 is disengaged, as can be appreciated.

The swivel locking device 133 can rotate around a swivel pin 145, which can serve as the pivot point for movement of the device 133. The swivel pin 145 can be securely attached to the coupling assembly 106 or integrated into the housing 109 of the peripheral device 100. In some cases, the swivel locking mechanism can incorporate additional features to enhance its functionality or durability. For example, the mechanism may include a damping element to control the speed of the swivel locking device 133 as it opens or closes. The locking pin 151 and corresponding engagement surfaces may be made of wear-resistant materials to ensure long-term reliability of the locking mechanism. The design of the swivel locking mechanism may allow for one-handed operation, enabling users to easily attach or detach the peripheral device 100 from keyrings or other objects while holding other items. This can enhance the overall usability and convenience of the device in various everyday scenarios.

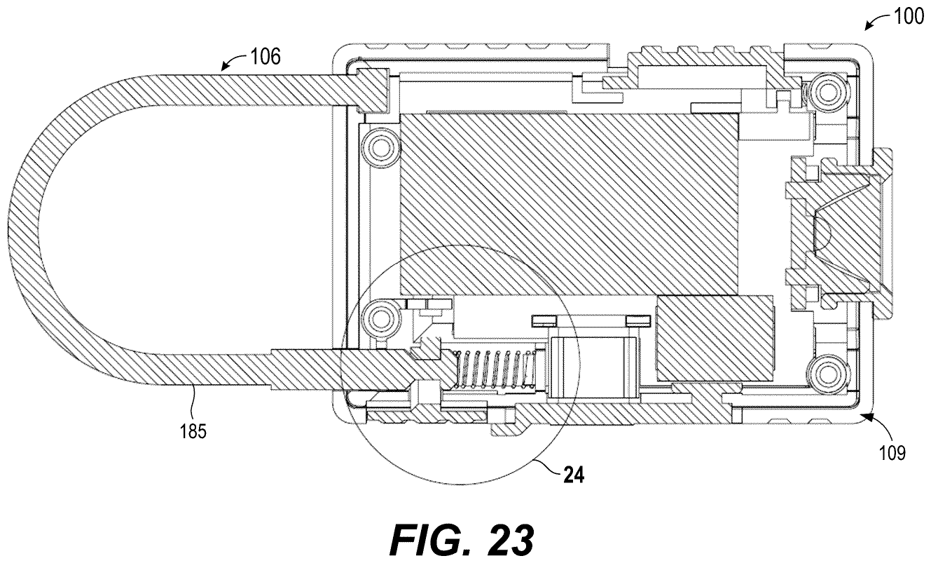

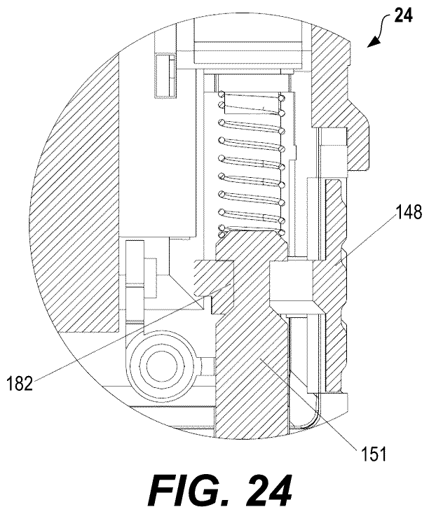

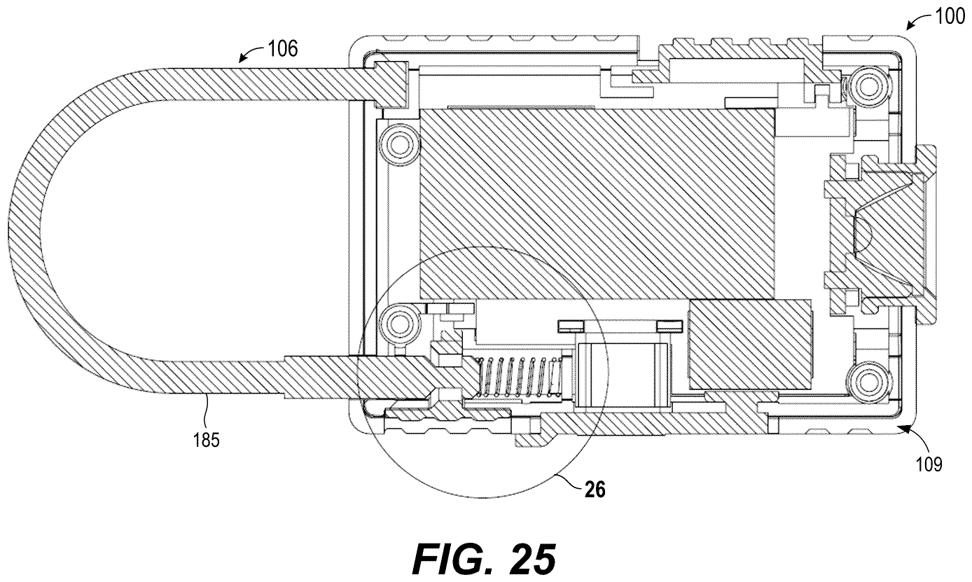

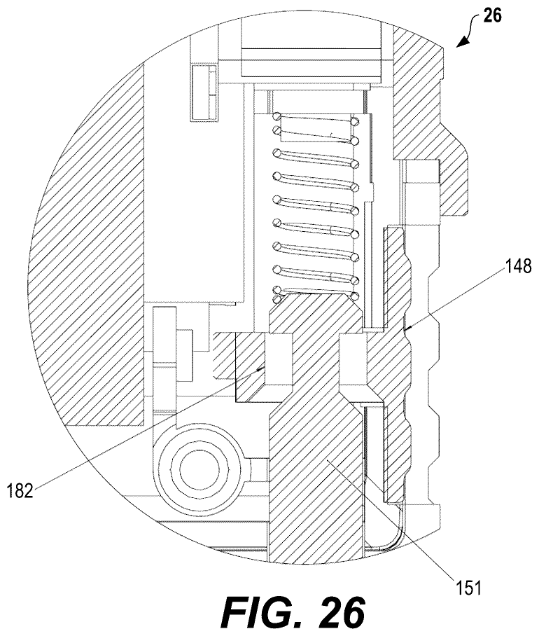

Referring next to FIGS. 23-26, alternative embodiments of the coupling assembly 106 are illustrated according to various aspects of the present disclosure. Specifically, FIG. 23 includes callout region 24, where callout region 24 is shown in enlarged detail in FIG. 24. Similarly, FIG. 25 includes callout region 26, where callout region 26 is shown in enlarged detail in FIG. 26. In these embodiments, the coupling assembly 106 may feature a flexible cable 185 in contrast to the rigid swivel locking device 133 described in the preceding figures.

The flexible cable 185 may provide an alternative attachment mechanism that offers versatility in various use scenarios. The flexible cable 185 may be constructed from materials such as braided steel wire, polymer-coated cable, or other suitable flexible materials that can withstand repeated bending and manipulation while maintaining structural integrity. In some implementations, the flexible cable 185 may include a protective outer sheath or coating to prevent fraying and enhance durability during extended use.

The flexible cable 185 may be coupled to the body portion 103 or housing 109 through first and second ends that allow for secure attachment while maintaining flexibility. This connection may incorporate strain relief features to prevent damage to the cable 185 at the attachment point during normal use. The flexible nature of the cable 185 may allow users to thread the peripheral device 100 through various attachment points or wrap it around objects in ways that may not be possible with rigid attachment mechanisms.

Similar to the previously described embodiments, the latching and unlatching mechanism of the flexible cable 185 may operate using comparable configurations. The release switch 148 may be manipulated to control the engagement and disengagement of the locking mechanism. When the release switch 148 is activated, the release switch 148 may cause the notch 184 to disengage from the latch 182 of the locking pin 151, where the locking pin 151 may be coupled to or form part of the flexible cable 185.

The locking pin 151 associated with the flexible cable 185 may be positioned at a terminal end of the cable or integrated into a connector assembly at a terminus of the cable 185. This may allow the flexible cable 185 to be securely attached to various objects while providing the same reliable locking mechanism as the rigid embodiments. The spring release latch assembly 180 may function similarly to maintain secure engagement until the release switch 148 is deliberately activated. In some aspects, the flexible cable 185 may include length adjustment capabilities, allowing users to modify the effective length of the cable for different applications. This may be achieved through a sliding mechanism, retractable design, or other suitable means that permit length customization while maintaining the integrity of the locking mechanism.

A number of implementations have been described. Nevertheless, it will be understood that various modifications may be made without departing from the spirit and scope of the disclosure. Accordingly, other implementations are within the scope of the following claims.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A peripheral device, comprising:
a body portion comprising a housing having processing circuitry housed therein;
a light-emitting element disposed at a first end of the body portion;
a power switch disposed on the housing for controlling the light-emitting element; and
a coupling assembly at a second end of the body portion opposite the first end, the coupling assembly comprising a swivel locking device detachably attachable to the housing, the swivel locking device configured to rotate between an open position and a closed position.

2. The peripheral device of claim 1, further comprising an alarm switch positioned on the housing and an acoustic transducer disposed within the housing and operatively connected to the alarm switch, the processing circuitry being configured to direct the acoustic transducer to emit alarm sound waves based on manipulation of the alarm switch.

3. The peripheral device of claim 2, wherein, when the alarm switch is in a first position, the processing circuitry is configured to direct the acoustic transducer to emit alarm sound waves and, in an instance in which the alarm switch is in a second position, the processing circuitry is configured to direct the acoustic transducer to not emit any alarm sound waves.

4. The peripheral device of claim 3, wherein a slider portion of the alarm switch is aligned within the slot in the housing, the alarm switch being compressible relative to the housing using a biasing element, and being slidable along a longitudinal axis of the housing when the alarm switch is compressed toward the housing.

5. The peripheral device of claim 1, wherein:
the swivel locking device comprises a locking pin configured to engage with the coupling assembly in the closed position; and
the peripheral device further comprises a release switch disposed on the housing, the release switch configured to disengage the locking pin from the coupling assembly.

6. The peripheral device of claim 1, further comprising a rechargeable power source disposed within the housing and electrically connected to the light-emitting element.

7. The peripheral device of claim 6, further comprising a charging port cover disposed on the housing, the charging port cover providing access to a charging port for the rechargeable power source.

8. A multifunctional keychain device, comprising:
a housing having a first end and a second end;
a light-emitting element positioned at the first end of the housing;
an alarm assembly disposed within the housing;
a power switch on a surface of the housing for controlling the light-emitting element;
an alarm activation mechanism positioned on the housing; and
a keychain attachment mechanism at the second end of the housing, the keychain attachment mechanism including a rotatable arm configured to secure a keychain ring.

9. The multifunctional keychain device of claim 8, wherein the light-emitting element comprises a light-emitting diode (LED).

10. The multifunctional keychain device of claim 8, wherein the alarm component comprises an acoustic transducer configured to emit an audible sound wave, the acoustic transducer comprising at least one of a speaker and a piezoelectric buzzer.

11. The multifunctional keychain device of claim 10, wherein the alarm activation mechanism comprises a slide switch configured to activate the audible alarm.

12. The multifunctional keychain device of claim 8, wherein the rotatable arm of the keychain attachment mechanism comprises a locking pin configured to secure the rotatable arm in a closed position.

13. The multifunctional keychain device of claim 8, wherein the alarm activation mechanism comprises a slider portion slidably engaged with the housing, the housing comprising a first support arm and a second support arm defining a slot therebetween, the slider portion being positioned within the slot and movable between a first position and a second position.

14. The multifunctional keychain device of claim 13, further comprising a biasing element operatively connected to the slider portion, the biasing element configured to bias the slider portion away from the housing, wherein the slide portion is compressible toward the housing against the biasing element and slidable along a longitudinal axis of the housing when compressed.

15. A peripheral device, comprising:
a body portion comprising a housing having processing circuitry housed therein, a power source, a light-emitting element disposed at a first end of the body portion electrically coupled to the power source, and a power switch disposed on the housing for controlling the light-emitting element; and
an alarm switch having a portion positioned on the housing and an acoustic transducer disposed within or on the housing and operatively connected to the alarm switch, the processing circuitry being configured to direct the acoustic transducer to emit alarm sound waves based on manipulation of the portion of the alarm switch,
wherein the alarm switch is aligned within the slot in the housing such that the alarm switch is compressible relative to the housing and slidable along a longitudinal axis of the housing when the alarm switch is compressed toward the housing.

16. The peripheral device of claim 15, further comprising:
a coupling assembly at a second end of the body portion opposite the first end, and a swivel locking device connected to the coupling assembly, the swivel locking device configured to rotate between an open position and a closed position,
wherein the swivel locking device comprises a locking pin configured to engage with the coupling assembly in the closed position, and the peripheral device further comprises a release switch disposed on the housing, the release switch configured to disengage the locking pin from the coupling assembly.

17. The peripheral device of claim 15, further comprising:
a flexible cable at a second end of the body portion opposite the first end, the flexible cable being configured to transition between an open position and a closed position,
wherein the flexible cable comprises a locking pin configured to engage with the coupling assembly in the closed position, and the peripheral device further comprises a release switch disposed on the housing, the release switch configured to disengage the locking pin from the coupling assembly.

18. The peripheral device of claim 15, wherein the acoustic transducer is configured to emit alarm sound waves at a decibel level of approximately 120 decibels.

19. The peripheral device of claim 15, wherein the power switch is configured to cycle the light-emitting element through multiple modes of operation, the multiple modes comprising at least one of continuous illumination, pulsating light, and flashing patterns.

20. The peripheral device of claim 15, further comprising a biasing element disposed within the housing and operatively connected to the alarm switch, the biasing element configured to bias the alarm switch away from the housing.
